(19) United States
(12) Patent Application Publication
(10) Pub. No.: US 2014/0324593 A1
(43) Pub. Date: Oct. 30, 2014

(54) Mobile Messaging and Data Tracking Platform

(71) Applicant: Shopping Made Mobile, Inc., Honolulu, HI (US)

(72) Inventors: Adam SCHUSTER, Honolulu, HI (US); George CHALEKIAN, Honolulu, HI (US)

(21) Appl. No.: 14/328,626

(22) Filed: Jul. 10, 2014

Related U.S. Application Data
(63) Continuation of application No. 13/528,769, filed on Jun. 20, 2012.
(60) Provisional application No. 61/499,100, filed on Jun. 20, 2011.

(51) Int. Cl. G06Q 30/02

(52) U.S. Cl. CPC G06Q 30/0261; G06Q 30/0267
USPC 705/14.58

(57) ABSTRACT

The invention provides methods, systems, and modules for sending messages to message-recipients based on targeting parameters and optional location data. Examplary embodiments of the invention are configured to operate in a geographic area defined by a collective such as a shopping mall comprising a plurality of tenants, wherein the message-senders include the tenants and a representative of the collective.

### CROSS-REFERENCE TO RELATED APPLICATIONS

This application priority to U.S. Provisional 61/499,100 filed 20 Jun. 2011, which is hereby incorporated by reference.

### TECHNICAL FIELD

The present invention relates to mobile device messaging and tracking of mobile devices.

### SUMMARY OF THE INVENTION

The invention provides methods, systems, and computer-readable media comprising modules for sending messages to mobile devices based on the location of the mobile devices and targeting parameters associated with the users of the mobile devices. Optionally, the mobile devices are located in a geographic environment defined by a collective of tenants (e.g. shopping mall) and unique messages are sent from a plurality of tenants and a collective representative.

An examplary system of the invention provides one or more mobile devices, a database, and a messaging server, wherein:
a. the mobile device (e.g. mobile phone) comprises an application that:
   i. provides one or more targeting parameters based on input from a user of the mobile device
   ii. determines the location of the mobile phone;
   iii. transmits the targeting parameters and the location to a messaging server, a database, or a combination thereof; and
   iv. receives messages from a messaging server;
b. the database comprises a plurality of entries associated with respective mobile devices, wherein each entry comprises:
   i. a unique identifier corresponding to a mobile device user;
   ii. targeting parameters corresponding to the mobile device user; and
   iii. optionally, location data corresponding to the mobile device of the mobile device user;
c. the messaging server comprises an application that:
   i. provides a message based on input from a user of the messaging server;
   ii. provides a target profile comprising targeting parameters and a target location, wherein the target profile is based on input from a user of the messaging server;
   iii. queries the database to determine a match between the targeting parameters of the target profile and the targeting parameters of the database;
   iv. queries the location of the mobile device to determine a match between the target location of the target profile and the location of the mobile device, optionally wherein said query comprises comparing the target location to:
      a) location data in the database; or
      b) a location received from the mobile device; and
   v. sends the message to the mobile device corresponding to said match.

In one aspect, the invention provides a method comprising:
a. receiving targeting parameters from one or more mobile device users;
b. determining the location of the one or more mobile devices of the mobile device users;
c. providing:
   i. a message;
   ii. a target profile for the message, wherein the target profile comprises:
      a) at least one targeting parameter associated with the message; and
      b) a target location associated with the message;
   d. determining whether the at least one targeting parameter of the target profile matches the targeting parameters of the at least one mobile device users;
   e. determining whether the location of the target profile matches the location of the one or more mobile devices;
   f. sending the message to at least one mobile device of the one or more mobile devices if:
      i. the at least one targeting parameter of the target profile matches the targeting parameters of the mobile device user of the at least one mobile device; and
      ii. the location of the target profile matches the location of the at least one mobile device.

In one embodiment, the location of the one or more mobile devices is in an environment comprising a collective of tenants. Optionally the tenants are retailers or vendors and the collective is selected from: a mall, a casino, an airport, and a high-traffic tourist area. Optionally, the step of providing a message comprises receiving the message (e.g. created based on user input to the messaging server) from a tenant or a collective-representative, optionally wherein said collective representative is a mall administrator.

In one embodiment, at least a first message is sent from a first tenant (e.g. via a first messaging server or a first user account of a message server) and at least a second message is sent from a second tenant (e.g. via a second messaging server or a second user account of a message server). Optionally, at least a third message is sent from a collective representative (e.g. via a third messaging server or a third user account of a messaging server). Optionally, the first, second, and third messages are targeted different target locations, wherein: the target location for the first message is closer in proximity to the first tenant than the second tenant, the target location for the second message is closer in proximity to the second tenant than the first tenant; and the target location for the third message encompasses a larger geographic area than that of the first location or the second location.

In one embodiment, determining the location of the one or more mobile devices comprises periodically receiving location data from the one or more mobile devices and identifying the local time corresponding to said periodically received location data (i.e. the local time at which the mobile device is at the location). Optionally, data is stored in a database, wherein said database data comprises: an identifier unique to the mobile device user, the targeting parameters corresponding to the mobile device user, the periodically received location data corresponding to the mobile device location, and the local time corresponding to said periodically received location data. Optionally, a report based on said database data is generated (e.g. for presentation to the user of a messaging server such as a tenant or a collective representative. Optionally, the report comprises duration of visit, duration of visit at the environment, duration of visit at the collective, duration of visit at a tenant of the collective, route taken through the collective, entry or exit points used, purchase history, response to messages, or social interaction while in the environment. Optionally, the report comprises the number of said one or more mobile devices in a designated location at a given local time (e.g. the report is generated in response to a query initiated by a collective representative or the report is sent to the collective representative (e.g. presented on the messaging server used by the collective representative) when said number of mobile devices is greater than a threshold level. Optionally, the designated location is selected from: the geographic area defined by the collective, a geographic area within the collective, wherein said a geographic area within the collective is smaller in area than the geographic area defined by the collective, optionally wherein the geographic area within the collective is an entrance of the collective. Optionally, a collective representative can set limitations on the data which is available for reporting to the tenants (e.g. a permission to allow one or more tenants to view the report, or portion thereof).

In any embodiment, the at least one targeting parameter of the target profile and the one or more targeting parameters based on input from a user comprise one or more user-authored parameters. Optionally, the user-authored parameters are selected from: gender of mobile device user, area code of mobile device user, and preferences of the mobile device user. Optionally, the targeting parameters comprise one or more of: category of retail goods or services (e.g. from a list of available goods categories), and retailer or tenant (e.g. from a list of available tenants or retailers in a collective).

In any embodiment, the message (e.g. message sent by a tenant of a collective) comprises an offer for sale (e.g. advertisement, a coupon, a voucher, or gift card). Additionally or alternatively, a message is sent (e.g. by a collective representative), wherein the message describes an upcoming event in the collective. Optionally, the user of the mobile device responds to the message by moving to the sender of the message (e.g. tenant) or to a location in proximity to the subject of the message (e.g. to the location of an upcoming event. Optionally, the user of the mobile device responds to the message by purchasing a good or service described by the message (e.g. by purchasing the good or service at a point of sale).

In one embodiment, a report is generated comprising data from the database, e.g. using a reporting module.

In one aspect, the invention provides a system for performing a method taught herein (e.g. any described above). The system comprises a messaging server and one or more mobile devices. The system is optionally configured to a) obtain targeting parameters (e.g. user-authored parameters and location data) from users of the mobile devices (‘message recipients’); b) obtain a target profile and message from a user of the message server (‘message sender’), match the target profile with the targeting parameters; and c) send the message to the mobile devices of users having matched targeting parameters. In one embodiment, the system is configuring in a geographic environment comprising a collective (e.g. mall) of tenants (e.g. retail stores), wherein the system comprises a plurality of message-senders: at least one representative of the collective (e.g. mall administrator) and at least one tenant representative (also referred to herein as ‘tenant’). In one embodiment, the system comprises a database for storing the targeting parameters obtained from the message recipients and optionally the system is configured to generate and present reports to the message-sender.

The systems, methods, and modules of the present invention can be used e.g. to increase shopper spending, tenant loyalty, and collective (e.g. shopping mall) revenue, and collective efficiency.

### BRIEF DESCRIPTION OF THE DRAWINGS

FIG. 1 depicts an examplary system fo the invention.

FIG. 2 depicts an examplary system fo the invention.

FIG. 3 depicts an examplary user interface for a message-creating module (e.g. “POST” tab), a matching module (e.g. “TARGET” tab or “TRIGGER” tab), and a sending module (e.g. “SAVE” tab).

FIG. 4 depicts a message presented on the mobile device of a message recipient.

FIG. 5 depicts a map of a collective presented on the device of a message recipient.

FIG. 6 depicts an examplary user interface for a reporting module.

### DETAILED DESCRIPTION OF THE INVENTION

As used here, the following definitions and abbreviations apply.
“Cellular device” means a mobile device comprising a cellular network adapter. In one embodiment the cellular device is a mobile phone or a cellular-enabled PDA or tablet PC (e.g. iPad™).
“Examplary” (or “e.g.” or “by example”) means a non-limiting example.
“Mobile device” means a computer comprising a wireless network adapter and a battery configured to power the computer. In one embodiment the mobile device is a cellular device.
“User-authored parameter” is targeting parameter that can be produced from input (e.g. text input) by the user (i.e. message recipient) of a mobile device or by selection from options on the mobile device. Examples of user-authored parameters include categories of products or goods, vendor or tenant (i.e. opting in or out for various vendors or tenants), and gender.

### Message

According to the present invention a message is sent to a message-recipient. The message can be any message that can be transmitted to one or more mobile devices of message-recipients. Optionally, the message describes a product or service. Optionally, the message is an offer for sale of a product or service.

In one embodiment, the message comprises one or more of: may text, graphics, audio, or video.

In one embodiment, the message is a message comprising text, graphics, a push notification, a Short Message Service (SMS) message, or a Multimedia Messaging Service (MMS) message. The push notification is optionally any message sent to a mobile phone from a message server using an internet protocol.

Offer For Sale

In one embodiment, the message comprises an offer for sale. Examples of messages comprising an offer for sale include an advertisement, a coupon, a voucher, and gift card.

In one embodiment, a user of a mobile device responds to the offer for sale (e.g. by entering a tenant's retail store in a mall in response to a message regarding a discounted product). Optionally, the user of the mobile device makes a purchase (e.g. while in a tenant's retail store or using electronic payment sites such as PayPal).

### Network

A system of the invention comprises a communications network (‘network’) to connect the database server, the one or more mobile device users, and the at least one messaging server (e.g. at least one additional mobile device or at least one wired server). The network can be any network that can transmit the data disclosed herein between the servers, the mobile devices, and any optional data-processing devices.

Useful networks include wireless networks, wired networks, and a combination thereof.

In one embodiment, the network comprises a wide area network (WAN) or a local area network (LAN).

In one embodiment, the network comprises a wide area network (WAN). Optionally, the WAN comprises the internet. Optionally, the WAN comprises a wireless WAN such a cellular network. Optionally, the WAN comprises the internet and a wireless WAN (e.g. cellular network).

In one embodiment, the network comprises a wireless network. Optionally, the wireless network comprises a cellular network, a wireless local area network, or a wireless metropolitan area network.

In one embodiment, the network comprises a cellular network. Useful cellular networks include Advanced Cellular telephone System (AMPS), Narrowband Advanced Cellular telephone Service (NAMPS), Frequency Shift Keying (FSK), Frequency Division Multiple Access (FDMA), Time Division Multiple Access (TDMA), and Code Division Multiple Access (CDMA), or any standard, such as Global System for Mobile communications (GSM) or Cellular Digital Packet Data (CDPD), a GPRS network, an EDGE network, a 3G network, and a 4G network.

The network can use any network protocol, for example, an internet protocol, TCP/IP or UDP, which are commonly used over the internet.

### Computers

A system of the present invention comprises a plurality of computers. Collectively, the plurality of computers comprises the one or more mobile devices, the messaging server, the database, and the modules (e.g. computer applications) configured to perform a method of the present invention. At least one of the computers is a database server comprising the database. At least one of the computers is a mobile device configured for interfacing and being carried by a user. A messaging server is also provided, which may be the same computer as the database server or a different one or more computers (e.g. the database and messaging-sending module are provided on a single server).

Computers useful in sale systems of the present invention comprise:
a. one or more processors;
b. one or more storage devices comprising a computer readable medium;
c. a network access device (or ‘network device’); and
d. a structure configured for connecting the one or more processors to the other components of the computer (e.g. storage device and network access device).

The database and/or modules can be stored on the computer readable medium accessible to a computer.

Useful computer-readable media includes any physical media configured to store code and be readable by a computer. For example, useful computer-readable media computer includes volatile media, nonvolatile media, removable media, non-removable media, RAM, ROM, EEPROM, flash memory or other memory technology, CD-ROM, digital versatile disks (DVD), holographic media or other optical disk storage, magnetic cassettes, magnetic tape, magnetic disk storage, or other magnetic storage devices.

Useful processors include any processor configured to access the one or more storage devices and the network access device. Examples of such processors are well known in the art and are commonly connected to the storage devices and network access devices by a system bus (e.g. on a motherboard).

Useful network access devices include any devices configured to transmit data between the computer and the network. Examples include network adapters wired adapters such as ethernet adapters and wireless adapters such as Wi-Fi adapters (e.g. 802.11 adapter) and cellular adapters (e.g. GSM, TDMA, CDMA, 3G, and 4G adapters).

Useful structures configured for connecting the one or more processors to other components include, e.g. a motherboard comprising a northbridge and southbridge. Other structures are well known in the art.

Other examples of useful computer architecture are described, for example, by US 2005/0262212, US 2008/0228600, US2008/0313037, US 2011/0270618, US 2012/0005016, US 2012/0096490, and WO/2009/035468 WO/2011/082041.

Mobile Device

A system of the invention comprises one or more mobile devices.

According to the present invention, the mobile device is any computer having the following technical features:
a. a user module configured to provide a graphic user interface (GUI), e.g. for interfacing with a messaging module;
b. a user input device;
c. a display; and
d. a wireless network adapter.

Examples of mobile devices include a mobile telephones phone, a handheld computer, a personal digital assistant (PDA), a tablet PC, a cellular phone, a smart phone, and a portable an email device.

In one embodiment, the mobile device is a cellular device. Optionally, the mobile device is a cellular device, wherein the cellular device is a cellular telephone or a cellular-enabled PDA or tablet PC (e.g. iPad™).

The user input device can be any device or combination of devices configured for operation by a user to operate the remote device and/or the user module. Optionally, the input device comprises a touch screen, a keypad, one or more buttons, one or more scroll wheels, or one or more buttons or other device that can be operated by a user. Optionally, the input device comprises a microphone or a camera.

The display can be any output device that produces a graphic viewable by the user. Optionally, the display is selected from: an LCD, an LED, and a monitor.

In one embodiment, at least one mobile device is configured for a message recipient (e.g. mall shopper), e.g. configured for receiving messages and optionally providing targeting parameters for the mobile device user. Optionally, an additional one or more mobile devices are configured for a message-sender (e.g. a tenant or a collective representative), e.g. configured for sending messages to mobile devices of message-recipients. The mobile devices can be configured, for the respective user (e.g. message recipient or message sender), for example, by providing one or more modules that are configured for carrying out the respective steps of a method of the present invention (e.g. a mobile device may be a message server), or by providing a web-enabled module that interacts with a module of a remote server (e.g. the messaging server is provided as a web-based application accessible to a mobile device of a message-sender and/or the message-receiving and tracking modules are configured as a web-based application accessible to a mobile device of a message-recipient).

In one embodiment, the mobile device is a mobile device of message recipient and the mobile device comprises location device. The location device (e.g. GPS device) can be any hardware useful for determining the location of the phone. Examples of useful technologies that can be implemented to provide a location include GPS WiFi, Wifi beacon identification (e.g. without data connectivity), Cell Phone Signals, triangulation, short range RF signals including RFID, BlueTooth, PANs, and Magnetic Field detection.

Other examples of useful mobile device architectures are described, for example, by US 2005/0262212, US 2008/0228600, US2008/0313037, US 2011/0270618, US 2012/0005016, US 2012/0096490, and WO/2009/035468 WO/2011/082041.

Database Server

A system of the invention comprises a database server comprising the database on a computer readable medium. The server can be configured in any manner that provides access to the database, e.g. by the matching module and/or the tracking module.

The database and server can be configured in any manner that provides identification data that identifies mobile device users (message recipients) and the respective targeting parameters associated with each mobile device user.

In one embodiment, the data comprises a plurality of entries, a database of entries, wherein each entry comprises an identifier set wherein:
a. the identifier set comprises:
   i. a user identifier unique to the mobile device or user; and
   ii. one or more targeting parameters associated with the mobile device user.

A database useful in the present invention need not be a single file and the database server need not be a single computer. For example, the database can be a collection of sub-databases (e.g. files) provided on different computers that comprise a data link between each other (e.g. all the database computers are connected to the network).

In one embodiment, the server is a single computer comprising the entire database on a single storage device. In another embodiment, the server is a single computer comprising the database as a plurality of database portions distributed across a plurality of storage devices. In another embodiment, the server is a plurality of computers, each comprising a database portion.

In one embodiment, a useful database entry is any collection or associations of identification data in a database, wherein the identification data comprises a user identifier, targeting parameters, and optional location data corresponding to the location of the mobile devices of message-recipients. The identification data can be provided in any manner that associates the user identifier and respective targeting parameters. The user identifier and the targeting parameters can be associated with each other in any manner. For example, the user identifier and the targeting parameters can be provided together in a line of code that is independent from that of other entries. Alternatively, the user identifier and the targeting parameters can be provided in the database in any manner that associates one with the other.

In one embodiment, a matching module compares a query comprising a target profile to database on the database server. In another embodiment, the database is downloaded from the database to a second computer (e.g. messaging server remote from the database server) and a matching module compares the query to the database on the second computer.

Other examples of useful database architectures and configurations are described, for example, by US 2005/0262212, US 2008/0228600, US2008/0313037, US 2011/0270618, US 2012/0005016, US 2012/0096490, and WO/2009/035468 WO/2011/082041.

Messaging Server

A system of the invention comprises a messaging server comprising one or more modules configured to create and send a message, e.g. a message-creating module and a message-sending module. The messaging server can also comprise one or more modules configured to create a target profile and/or match the target profile with targeting parameters of the database, e.g. a matching module.

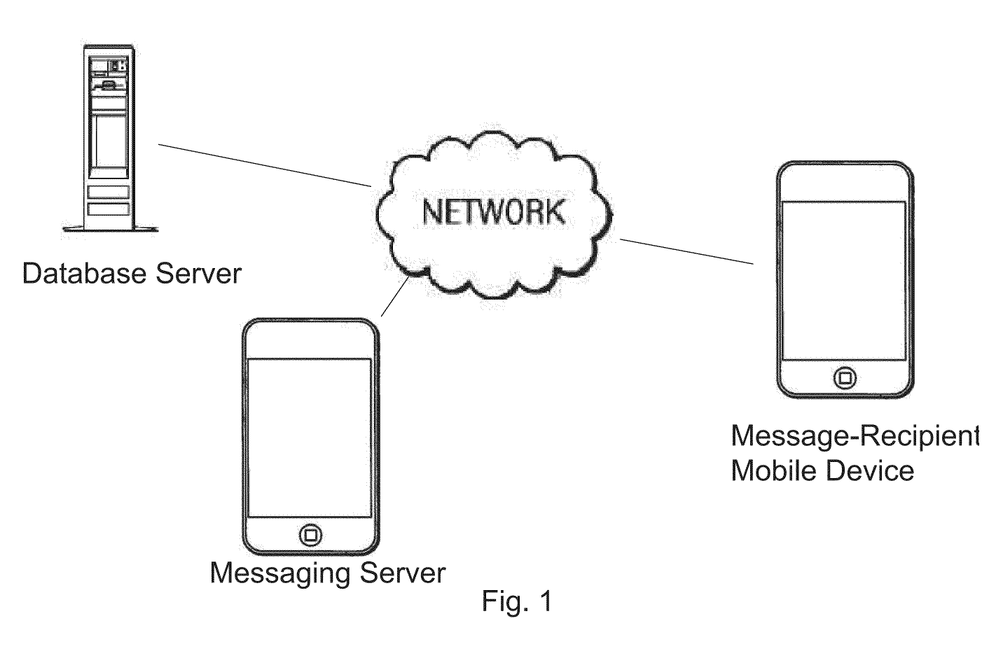

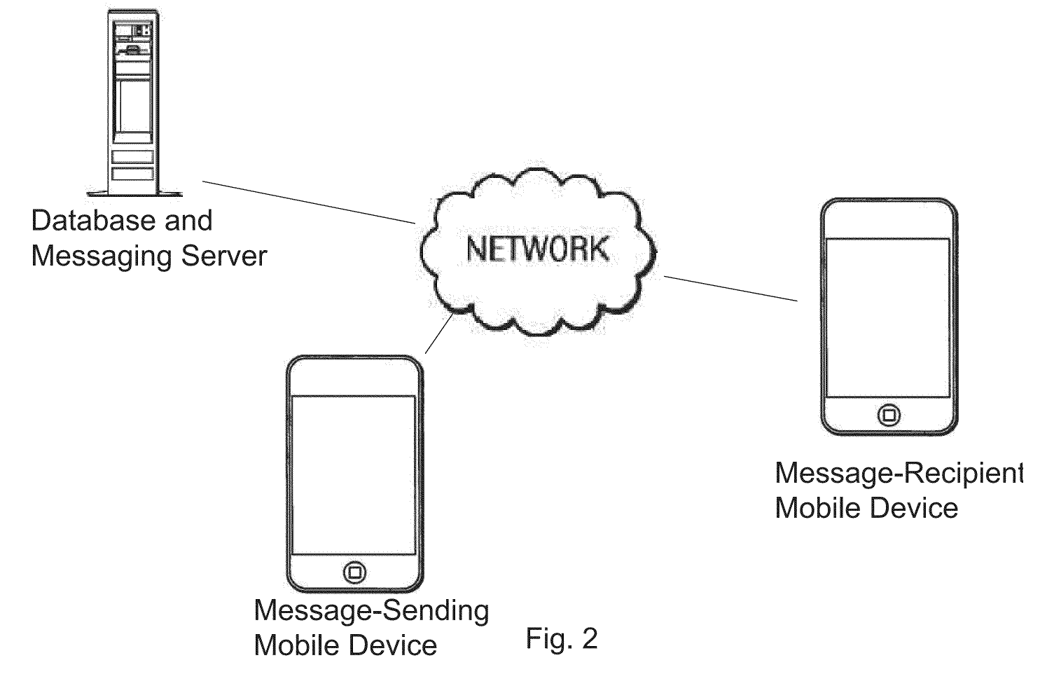

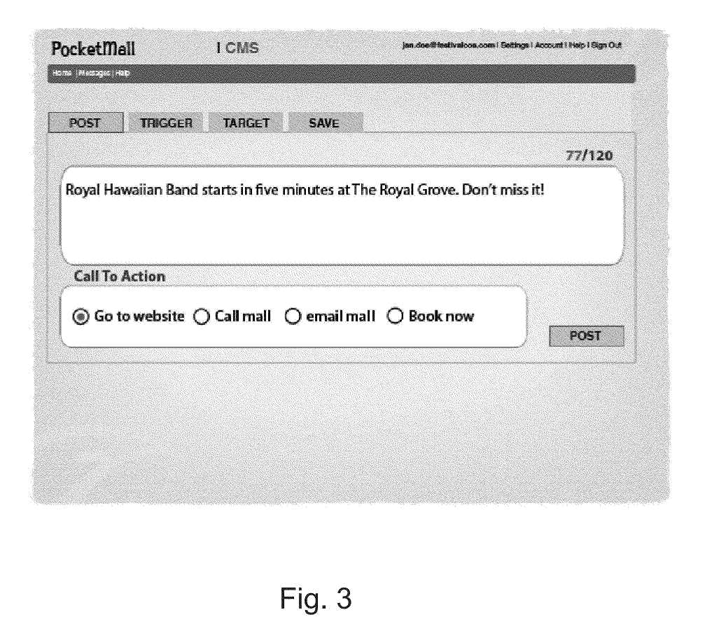

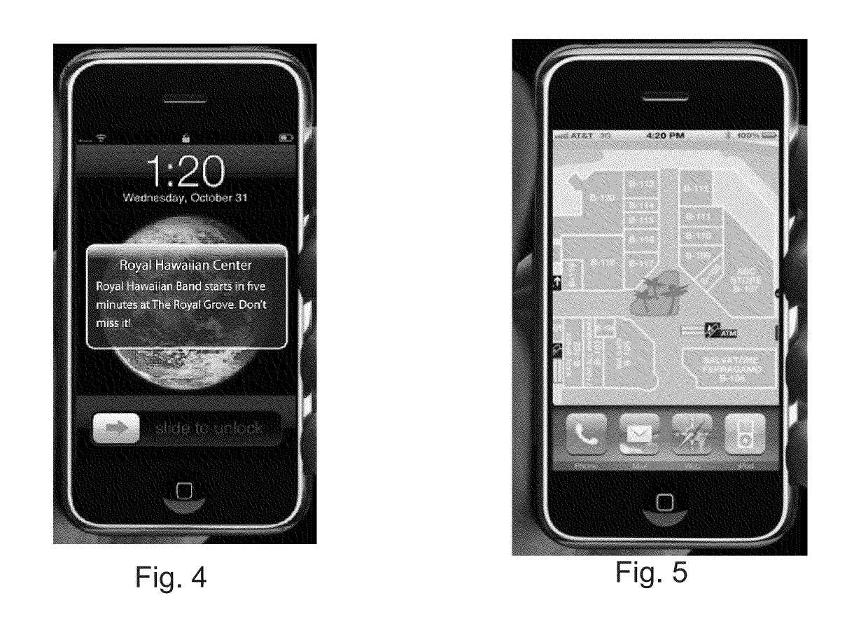

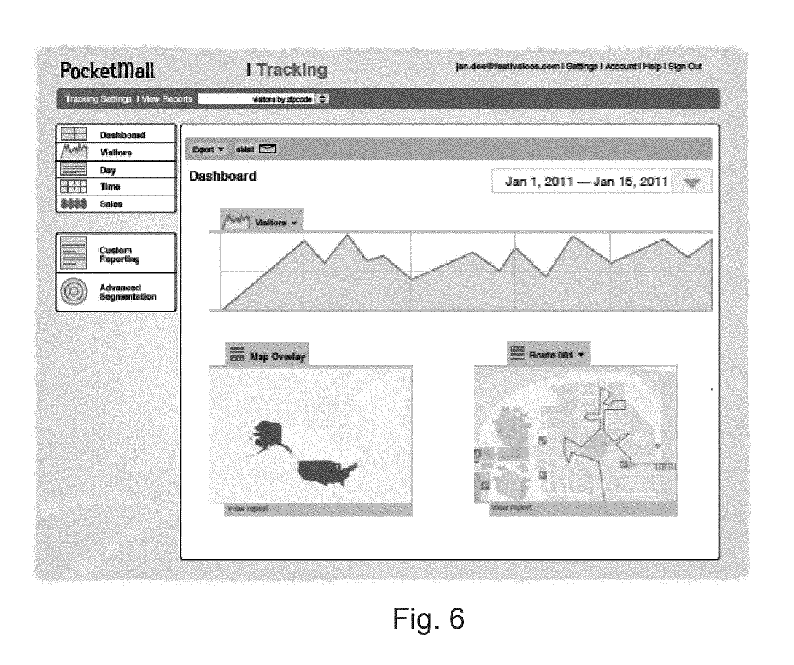

In one embodiment, the server is networked with the database server (e.g. as depicted in FIG. 1) or is the same computer as the database server (e.g. as depicted in FIG. 2).

In one embodiment, the messaging server comprises a GUI for interacting with a messaging sender, e.g. (e.g. as depicted in FIG. 1). Alternatively, the messaging server is remote from the computer of the message-sender (e.g. as depicted in FIG. 2).

In one embodiment, the messaging server is a mobile device.

Other examples of useful messaging server architectures and configurations are described, for example, by US 2005/0262212, US 2008/0228600, US2008/0313037, US 2011/0270618, US 2012/0005016, US 2012/0096490, and WO/2009/035468 WO/2011/082041.

### Identification Data

In one embodiment of the present invention, identification data are provided that correspond to users of mobile devices (message recipients) and the respective targeting parameters corresponding to the respective mobile device user. The identification data or targeting parameters thereof optionally comprises a location of a respective mobile device (‘location data’).

In one embodiment, the identification data is stored in on a database, for example, transmitted to the database from a tracking module or a mobile device of a message-recipient and then accessed by a messaging server, a matching module, or a reporting module. Additionally or alternatively, the identification data is transmitted from a message-recipient to a messaging server.

Other examples of useful identification data are described, for example, by US 2005/0262212, US 2008/0228600, US2008/0313037, US 2011/0270618, US 2012/0005016, US 2012/0096490, and WO/2009/035468 WO/2011/082041.

User Identifier

In one embodiment, the identification data comprises a user identifier. The user identifier is any identifier that is unique to a user of a mobile device (e.g. mall shopper). In one embodiment, the user identifier is an alphanumeric identifier or a serial number.

Targeting Parameters

Targeting parameters are any identification data that are associated with a user of a mobile device or the mobile device of the user. Typically, the entire set of targeting parameters is not shared by all mobile device users.

In one embodiment, the targeting parameters include one or more user-authored parameters, e.g. gender of mobile device user, area code of mobile device user, spoken language of the mobile device user, and/or preferences of the mobile device user. Optionally, the targeting parameters comprise one or more preferences selected from: category of retail goods or services (‘goods’), and retailer or tenant.

In one embodiment, the targeting parameters include one or more transient parameters. A transient parameter is a targeting parameter that is dependent upon continuously changing variables of the message recipient's mobile device. For example, transient parameters can include any of: day (e.g. day of the week), date, time (e.g. local time or duration at location), and location (e.g. proximity to message-sender or absolute location such as GPS location). Transient parameters such as time, date, day, or number of times a mobile device has visited a geographic area (e.g. collective or tenant) can be determined by the mobile device of the message-recipient upon sending location data to a database or message-sender or can be determined by any other computer (e.g. database or computer of a message sender receiving location tracking data from the mobile device of a message recipient).

Location Data

Location data comprises a location identifier specific to a geographic location.

The geographic location can be of any size and shape, e.g. a single point such as a GPS coordinate or a defined geographic area. For example, the location can be any of: a) the geographic area defined by a retail environment or a collective (e.g. mall perimeter); b) a geographic area within or in proximity to a tenant or retail store (e.g. area defined by an arc with a radius (e.g. less than about 50 feet) extending from a point defined by an entrance to the tenant or retail store); or c) a single point within any of a)-c).

In one embodiment, the location data further comprises a local time associated with the location identifier. The local time is optionally be used in combination with the location of the mobile device of a message-recipient to track the movement and transient location of the mobile device.

Target Profile

According to the present invention, a target profile is provided comprising one or more targeting parameters. Optionally, the target profile comprises at least one user-authored parameter (e.g. goods category or tenant) and at least one transient parameter (e.g. location and/or time or date).

A target profile can be compared and matched with the identification data (e.g. targeting parameters) associated with message-recipients and/or the mobile devices thereof. The target profile can be associated with a message or a report for targeting the message or the report for the message-recipients matched with the target profile.

In one embodiment, a tenant provides a first target profile comprising a first location identifier and a collective representative provides a second target profile. Optionally, the second target profile does not comprise a location identifier. Alternatively, the second target profile comprises a second location identifier, wherein the geographic location designated by second location identifier is greater in area than the geographic location designated by the first location identifier. Such a technical feature provides, for example, a collective representative a greater area to target messages or reports than the tenant. For example, the second location identifier can designate the geographic area defined by the entire collective and/or the first location identifier designates a geographic area within the collective such as an area in close proximity to the tenant.

In one embodiment, the target profile targets a future event, for example, wherein the target profile comprises a day, time, or date or range thereof that that is later than the local time at which the target profile is created. For, example, a tenant may wish to create a target profile which targets mobile device users that will be a specific location at a future time or date.

In one embodiment, the target profile targets a current event, for example, wherein the target profile does not comprise a day, time, or date or range thereof wherein the target profile comprises the current day (or day range encompassing the current day) or date (or date range encompassing the current date) or the current local time (or a time range which encompasses the local time). For, example, a tenant may wish to create a target profile which targets mobile device users that are at a specific location.

### Modules

According to the present invention, a module is provided on a computer-readable medium. Modules are compilations of instructions (‘code’) executable by one or more computers to perform a function. The modules can be provided on any computer readable media (e.g. storage devices) assessable by the one or more computers. Any type of module is useful in the present invention. Collectively, the modules are configured for providing any method of the present invention. Although detailed module logic/procedures are provided for certain steps in the present methods, the skilled artisan, with the teachings provided herein, can readily configure the modules to provide any methods or steps taught herein in a number of manners.

In one embodiment, a system of the present invention comprises a tracking module, a message receiving module, a message-creating module, a message-sending module, and a matching module. The modules can be stored on the same or different computer readable media. The modules can be included together in a single application (e.g. located on a remote server, wherein the application can access the database and is accessible to mobile devices of message-recipient and computers such a mobile devices of message-senders) or can be included in distinct applications configured to interact with each other to provide the methods taught herein.

The modules can be configured, for example, as a program, an application, an applet, a macro, a script, a subroutine unit of code, a software function unit of code, an object (as in an object-oriented paradigm), firmware, or any other type of computer code. The code can include any code, e.g. source code, object code, machine code, or any other stored data that is operable to cause a processing system to perform methods described herein.

The code and functionality of a given module can be located on a single computer or distributed across multiple computers.

In one embodiment, the modules are collectively configured for a) receiving targeting parameters from a message-recipient, b) determining the location of the mobile device of the message-recipient, c) storing the targeting parameters and optionally the location on a database, d) receiving a message from a message-sender; e) receiving a target profile from a message-sender, f) determining a match between the target profile and the targeting parameters of the message-recipient, and g) sending the message to the mobile device of a message-recipient associated with the match. Optionally, the modules are further collectively configured for generating a report of the database and optionally displaying the report to a message-sender.

In one embodiment, the modules are collectively configured for determining the local time (e.g. by providing or accessing a local time clock). The local time can be used by the system in combination with the location of the mobile device to track the movement and transient location of the mobile device.

In one embodiment, the modules are collectively configured for determining the geographic location of the mobile device (e.g. the database or messaging module receiving location data comprising a location identifier from a tracking module of the mobile device). The geographic location can be used by the system, for example, in order to determine whether the user is in the target location (e.g. in proximity to a collective, or at the entrance of a tenant or of a collective).

With the teachings provided herein, the skilled artisan can readily product systems of the present invention. Examples of modules and module configurations useful in the present are independently known in the art. For example, various useful architectures and configurations for messaging modules (e.g. creating, sending, receiving), matching modules, message sending, targeting parameters, and databases are described by US 2005/0262212, US 2008/0228600, US2008/0313037, US 2011/0270618, US 2012/0005016, US 2012/0096490, and WO/2009/035468 WO/2011/082041.

Message Receiving Module

A system of the present invention can comprise a message receiving module configured for receiving messages over the network adapter of a mobile device and presenting the messages to the user of the mobile device (‘message recipient’).

In one embodiment, the message receiving module is provided on the mobile device of a message recipient. In another embodiment, the message receiving module is provided on a remote server and the mobile device comprises a user module (e.g. web browser or web-enabled application) configured to interface the user.

Tracking Module

A system of the present invention can comprise a tracking module configured for a) allowing a mobile device user (message-recipient) to input or select targeting parameters; b) determine the location of the mobile device; and c) transmit the targeting parameters and location to a database or the computer of a message-sender.

In one embodiment, the tracking module is provided on the mobile device of a message recipient. In another embodiment, the message receiving module is provided on a remote server and the mobile device comprises a user module (e.g. web browser or web-enabled application) configured to interface the user. In one embodiment, the tracking module is a composed of interacting-modules located on different computers on the network.

In one embodiment, a message creating module can comprise a user module or can be configured to interact with a user module.

In one embodiment, the tracking module is composed of a location tracking module configured for determining the location of the mobile device and a targeting parameter tracking module configured for providing one or more targeting parameters in response to a user action (e.g. user input or selection from on-screen options). The location tracking module optionally repeatedly (e.g. continuously) determines the location of the mobile device, e.g. to provide the real-time location of the mobile device of a message-recipient and/or provide movement data of the mobile device. The targeting module is optionally configured to allow the user to modify targeting parameters at will, e.g. to provide updated user-authored targeting parameters.

Message Creating Module

A system of the present invention can comprise a message-creating module configured for creating a message, optionally wherein said message is created from a first user input.

In one embodiment, the message creating module is provided on a mobile device of a message-sender. In another embodiment, the message receiving module is provided on a remote server and the mobile device comprises a user module (e.g. web browser or web-enabled application) configured to interface the user.

In one embodiment, a message creating module can comprise a user module or can be configured to interact with a user module.

Message Sending Module

A system of the present invention can comprise a message sending module for sending a message to a message recipient. In one embodiment, the message sending module is configured to send a message to a message-recipient identified by a matching module (i.e. matching a target profile).

In one embodiment, a messaging sending module can comprise a user module or can be configured to interact with a user module.

Matching Module

In one embodiment, a matching module is provided for matching a target profile with targeting parameters corresponding to a message-recipient or mobile device thereof. Optionally, the matching module comprises code configured for:
a. receiving a user input;
b. creating a query based on the user input, wherein the query comprises a target profile of targeting parameters;
c. comparing the target profile with the targeting parameters corresponding to one or more message-recipients;
d. identifying at least one match between the target profile and the targeting parameters corresponding to one or more message-recipients; and
e. identifying the message-recipient associated with at least one match, thereby providing at least one matched mobile device user.

In one embodiment, the user input comprises any of: a selection from a list of user inputs (e.g. list of available targeting parameters) and a text input (e.g. keyword described a targeting parameter).

In one embodiment, upon receiving a user input, the query module creates a query in a form that can be compared to the targeting parameters in the database to identify a match.

In one embodiment, the matching module is provided on a messaging server. Optionally, the messaging server is a mobile device (e.g. of a tenant or collective representative) or a web-based server accessible to a mobile device (e.g. of a tenant or collective representative).

In one embodiment, the matching module is configured for use by different users, for example, the matching module can be configured with a plurality of user accounts or account types (e.g. a tenant account and a collective representative account). Optionally, the plurality of user accounts or account types provide the user with choices of targeting parameters to create the query (e.g. a tenant account has more limited choices than a collective representative account). Optionally, the plurality of user accounts or account types are configured to create queries with different limitations on the geographic area size that is allowed for targeting (e.g. a tenant account is limited to smaller geographic area size than a collective representative account). Optionally, the matching module requires user authentication (e.g. after registering for the messaging server using a registration module).

In one embodiment, the tracking module is configured to repeat (e.g. continuously repeat) the steps of comparing, identifying at least one match, and identifying at least one mobile device and send the match to the message-sending module for sending to a mobile device of a message-recipient. Such a configuration is useful, for example, for providing an on-going trigger that sends a message any time a mobile device user matches the target profile.

In one embodiment, a matching module can comprise a user module or can be configured to interact with a user module.

Accordingly, the matching module can be used to target specific message-recipients (e.g. mall shoppers) increase shopper spending, tenant loyalty, and collective (e.g. shopping mall) revenue, and collective efficiency.

Registration Module

In one embodiment, a system of the present invention comprises a registration module. The registration module comprises code for registering and authenticating a user with the system or with a component thereof (e.g. a message-receiving module, a matching-module, or a message-sending module). The users optionally comprise a message-recipient, a message-sender, or both.

In one embodiment, registering a user with the sale system comprises providing user information. Optionally, the user information comprises one or more (e.g. each) of: user name, user address, user phone number or area code, user email address, and payment information.

In one embodiment, the registration module passes user information to a message-sending module (e.g. to enable the tenant user to create and send messages) or a message receiving module (e.g. to enable the mobile device user to receive messages from a message sender).

User Module

Systems of the present invention comprise at least one module that sends or receives information to/from a human user (‘user module’). For example, a message-sending can create a message based on input from a computer (e.g. mobile device) of a message-sender, a matching module can create target profile based on input from a computer of a message-sender, and a message-receiving module can present messages to a message-recipient (e.g. mall shopper) on a mobile device.

The user module is any module that comprises code configured to provide a graphic user interface (GUI) operable to allow a user of a mobile device or message server to interact with the other modules of the system.

In one embodiment, a first user module is provided for interfacing a message-recipient on a mobile device and a second user module for interfacing a message-sender on a computer (e.g. mobile device).

An exemplary user module is configured to:
a. receive information from another module or line of code;
b. present information to a user (e.g. a message, a list of choices or options such a list of selectable targeting parameters for selection by a message-recipient or a message-sender);
c. prompt the user to provide a user input;
d. accept user input; and
e. transmit the user input to another module or line of code.

In one embodiment, a user module is a mobile phone application. Examples of application formats include iPhone and android operating systems. Such a user module can be configured to interact with (receive data from and/or transmit data to) a local or remote module selected from a message-receiving module, a message-sending module, a matching module, and a reporting module.

In one embodiment, the user module is a web browser (e.g. internet explorer or Mozilla fire fox). A web browser is useful, for example, when interacting modules (e.g. message-sending, message-receiving, matching, or reporting module) are provided on a server remote from the computer having the user module, e.g. when the interacting module is configured as web-based applications.

In one embodiment, the user module is configured to accept a user input selected from: option selection, text. In such embodiments, the user module can be configured for communicating with one or more buttons (e.g. touchscreen buttons) and/or a text input device (e.g. keyboard or touchscreen).

In one embodiment, the GUI provides the user with an efficient and user-friendly display of data provided by or communicated within the system. In one embodiment, the GUI comprises one or more customizable frames or views having interactive fields, pull-down lists, and/or buttons operated by the user.

Reporting Module

A system of the present invention can optionally comprise a reporting module configured to: access the database, create a report based on the data in the database, or a subset of data in the database.

In one embodiment, the report is generated by or presented to a message-sender, the messaging server, or a user of the messaging server (e.g. on mobile device of a message-sender).

In one embodiment, the report comprises location tracking information of the mobile devices of message-recipients. For, example, the tracking information can comprise a plurality of movement data, each comprising
a. a location identifier corresponding to a location (e.g. GPS location); and
b. a time identifier corresponding to the time the respective mobile device was at said location.

Optionally, the time identifier indicates the local time, the relative time (e.g. 3 min after trip start), or an amount of time at a given location (e.g. 30 sec at a GPS coordinate).

In one embodiment, the reporting module is configured to limit the data available for reporting. For example, the system or messaging server thereof can be configured for at least two types of message-senders (e.g. tenant and collective representative having different accounts on the messaging server or having different messaging servers), wherein a first sender of the message-senders (e.g. collective representative) can generate a report based on any available data in the database and a second sender of the message-senders are limited to generating reports having certain data (e.g. tracking data from common areas of a collective and areas within a first tenant's retail store but not areas within a second's tenant's retail store.

In one embodiment, the reporting module is configured to allow a first message sender (e.g. collective representative) to put limitations or restrictions on a second message sender (e.g. tenant) with respect to the data available for reporting.

In on embodiment, the reporting module is configured to provide any (e.g. each of) the following reports: duration of visit, duration of visit at the environment, duration of visit at the collective, duration of visit at a tenant of the collective, route taken through a collective (e.g. mall), entry or exit points used, purchase history (e.g. determined by redemption of coupons sent in messages), response to messages (e.g. determined by identifying movement of a message-recipient mobile device towards a tenant that has sent a message to the recipient and/or duration of stay at a tenant after receiving a message), or social interaction while in the environment (e.g. determined by identifying chat messages sent between mall shoppers or coincident movements between mall shoppers).

In one embodiment, the reporting module is configured to the number of message-recipient mobile devices in a designated location at a given local time. Optionally, the report is generated in response to a query initiated by the collective representative or the report is sent to the collective representative (e.g. messaging server or mobile device of a collective representative) when said number of mobile devices is greater than a threshold level. Optionally, the designated location is selected from: the geographic area defined by the collective and a geographic area within the collective; wherein said a geographic area within the collective is smaller in area than the geographic area defined by the collective. Optionally, the geographic area within the collective is an entrance of the collective.

In one embodiment an action is taken in response to the reports. Useful actions include, for example, modifying a message (e.g. content or targeting parameters), modifying prices (e.g. of goods described by messages), modifying marketing campaigns, or instructing staff (e.g. employees of a collective (e.g. mall) or tenant thereof) to perform specific functions (e.g. delegating additional staff to a busy mall entrance). As one example, a tenant optionally correlates effectiveness of a message with the selected target profile and modifies the target profile.

Accordingly, reports can be used to increase shopper spending, tenant loyalty, and collective (e.g. shopping mall) revenue, and collective efficiency.

Other Modules

In one embodiment, the system comprises one or more additional modules. For example, the system can comprise one or more modules that provide on the mobile devices of message recipients any of the following: a store directory and/or map of a collective (e.g. as depicted in FIG. 5), shopping list, parking spot locator, peer-peer (message recipient-recipient) chat program, info buttons for important areas (ATM's, elevators, bathrooms, info desks), event subscription and notification, public transportation schedules, and a VIP/rewards program. Other useful functions that can be provided on the mobile devices of message-recipients include: mapping technology, geo-tagging and geo-fencing, social “check-in” functionality, integration with social media in general, 3D rendering (e.g. as used with Yelp's “Monocle” or the mobile app “Layar”), advanced advertising capabilities and media, barcode scanning and generation technology, and NFC (“Near Field Communication”) and other payment technologies that will support purchases and subscriptions using a mobile device of a message recipient.

### Goods or Services

In one embodiment, the message sent to the mobile device user is associated with one or more goods or services (‘goods’). For example, the message can contain an advertisement, a coupon, a voucher, or a gift card, and optionally, the message is sent from a computer of a tenant.

In one embodiment, the product is any of: an apparel article, a consumable, a tool, an electronic device, a home appliance, and kitchen appliance, and a food substance.

In one embodiment, the product is an apparel article. Examples include clothes (e.g. shirts, pants, or outerwear), jewelry, shoes, and fashion articles.

In one embodiment, the product is a consumable. Examples include grocery items such as food or cleaning supplies, cosmetics, drugs, and disposable products.

In one embodiment, the product is a tool. Examples include appliances such as kitchenware and kitchen appliances, gardening tools, and automotive tools.

In one embodiment, the product is an electronic device. Examples include phones, computers, computer accessories, media players, gaming consoles, and televisions.

In one embodiment, the product is not a media (e.g. audio and/or video) product, a sample of which is presented during the media event. For example, if the media event comprises an audio sample, the product is not a song (or album) comprising the audio sample.

The following examples are non-limiting illustrations of examplary embodiments of the present invention.

### EXAMPLES

### Example 1

### System

A system is provided. The system comprises a database server, a messaging server, and a mobile device connected by a network (e.g. internet), as depicted in FIG. 1 or FIG. 2. As one example, the messaging server can be remote from the database server (e.g. a computer or mobile device operated by a message sender), as depicted in FIG. 1. As an alternative example, the message server and the database server can be the same computer, as depicted in FIG. 2.

The system is useful for a sending a message from the messaging server to the mobile device if the mobile device or user thereof (message-recipient) matches a target profile associated with the message appearing in media events presented to the user (e.g. via television broadcast).

The database server comprises a database of entries, wherein each entry corresponds to a respective mobile device or user thereof and comprises: a unique user identifier and a plurality of targeting parameters associated with the mobile device user corresponding to the user identifier.

The system further comprises a tracking module configured to receive targeting parameters from the message-recipient, determine the location of the mobile device of the message-recipient, and transmit the targeting parameters and the location to the database. The tracking module is, for example, provided on the mobile device of the message-recipient or on the database server.

The system further comprises a message-receiving module configured for receiving messages from the message server or mobile device of a message-sender and presenting the messages to the mobile device of the message recipient. The message-receiving module is, for example, provided on the mobile device of the message-recipient.

The system further comprises a message-creating module configured to create a message based on input (e.g. text entry) from a message-sender using the messaging server.

The database server can comprise a matching module configured to access the database and compare and match with the database of entries, a target profile selected by a message-sender using a messaging server which may be different than the database server, as depicted in FIG. 1, or the same as the database server as depicted in FIG. 2.

The system further comprises a message-sending module configured to send the created message to the mobile device matching the target profile.

In one embodiment, the system comprises a plurality of message-sending computers, e.g. a plurality of messaging servers or a plurality of mobile devices operated by different message senders. Optionally, a plurality of the message-sending computers are operated by tenants of a collective and at least message-sending computer operated by a representative of the collective (e.g. mall administrator).

The citations provided herein are hereby incorporated by reference for the cited subject matter.

What is claimed is:

1. A method comprising:
a. receiving targeting parameters from one or more mobile device users, optionally wherein the targeting parameters comprise a user-authored targeting parameter;
b. determining the location of the one or more mobile devices of the mobile device users;
c. providing:
i. a message;
ii. a target profile for the message, wherein the target profile comprises:
1. at least one targeting parameter associated with the message, optionally wherein the at least one targeting parameter is a user-authored targeting parameter; and
2. a target location associated with the message;
d. determining whether the at least one targeting parameter of the target profile matches the targeting parameters of the at least one mobile device users;
e. determining whether the location of the target profile matches the location of the one or more mobile devices;
f. sending the message to at least one mobile device of the one or more mobile devices if:
i. the at least one targeting parameter of the target profile matches the targeting parameters of the mobile device user of the at least one mobile device; and
ii. the location of the target profile matches the location of the at least one mobile device.

2. The method of claim 1, wherein the location of the one or more mobile devices is in an environment comprising a collective of tenants, optionally wherein:
a. the tenants are retailers or vendors; and
b. the collective is selected from: a mall, a casino, an airport, and a high-traffic tourist area.

3. The method of claim 2, wherein the step of providing a message comprises receiving the message from a tenant or a collective-representative, optionally wherein said collective representative is a mall administrator.

4. The method of claim 3, further comprising repeating steps b)-f) a plurality of times, wherein:
a. a first of said repeated step of providing a message comprises receiving a first message from a first tenant of the collective;
b. a second of said repeated step of providing a message comprises receiving a second message from a second tenant of the collective;
c. a third of said repeated step of providing a message comprises receiving a third message from a collective representative, optionally wherein said collective representative is a mall administrator; and
d. the at least one mobile device of each set of repeated steps b)-f) is the same or different; and
e. optionally:
i. the target location for the first message is closer in proximity to the first tenant than the second tenant;
ii. the target location for the second message is closer in proximity to the second tenant than the first tenant; and
iii. the target location for the third message encompasses a larger geographic area than that of the first location or the second location.

5. The method of claim 2, wherein determining the location of the one or more mobile devices comprises receiving location data from the one or more mobile devices, optionally wherein receiving location data comprises periodically receiving location data and identifying the local time corresponding to said periodically received location data.

6. The method of claim 5, wherein the method further comprises, for each of said mobile device users, storing data in a database on a computer-readable medium of a server,
a. wherein said database data comprises:
i. an identifier unique to the mobile device user;
ii. the targeting parameters;
iii. the periodically received location data; and
iv. the local time corresponding to said periodically received location data; and
b. wherein the database server is in a network with the one or more mobile devices.

7. The method of claim 6, further comprising providing a report based on said database data.

8. The method of claim 7, wherein the report comprises duration of visit, duration of visit at the environment, duration of visit at the collective, duration of visit at a tenant of the collective, route taken through the collective, entry or exit points used, purchase history, response to messages, or social interaction while in the environment.

9. The method of claim 7, wherein the report comprises the number of said one or more mobile devices in a designated location at a given local time, optionally wherein:
a. the report is generated in response to a query initiated by the collective representative; or
b. the report is sent to the collective representative when said number of mobile devices is greater than a threshold level.

10. The method of claim 9, wherein the designated location is selected from:
a. the geographic area defined by the collective;
b. a geographic area within the collective, wherein said a geographic area within the collective is smaller in area than the geographic area defined by the collective, optionally wherein the geographic area within the collective is an entrance of the collective.

11. The method of any of claims 1-10, wherein the targeting parameters comprise one or more of: gender of mobile device user, area code of mobile device user, and preferences of the mobile device user.

12. The method of claim 11, wherein said preferences comprise one or more of: category of retail goods, and retailer or tenant.

13. The method of any of claims 1-10, wherein sending the message comprises sending a message comprising text, a push notification, a Short Message Service message (SMS), or a Multimedia Messaging Service message (MMS).

14. The method of any of claims 1-13, wherein the one or more mobile devices are mobile telephones.

15. The method of any of claims 1-13, wherein the step of providing a message comprises creating a message using a computer, wherein the computer is in a network with the one or more mobile devices of the one or more mobile device users, optionally wherein the computer is operated by a tenant or a collective representative to send the message.

16. The method of claim 15, wherein the computer is a mobile device, optionally wherein the mobile device is a mobile telephone.

17. The method of any of claims 1-16, wherein the location is determined by a GPS device of the one or more mobile devices.

18. The method of any of claims 7-16, further comprising: receiving from a networked computer of a collective representative, a permission to allow one or more tenants to view the report, or portion thereof.

19. The method of claim 18, further comprising presenting the report, or portion thereof, to one or more networked computers of said one or more tenants.

20. The method of any of claims 1-16, wherein the message is an offer for sale, optionally wherein the offer for sale is selected from: an advertisement, a coupon, a voucher, and a gift card, and optionally, the message is sent from a computer of a tenant.

21. The method of any of claims 2-16, wherein the message describes an upcoming event in the collective, and the message is sent from a computer a collective representative.

22. The method of any of claims 2-16, further comprising presenting on the one or more mobile devices:
a. a map of the collective;
b. a tenant directory of the collective; or
c. both a and b.

23. The method of claim 20, wherein a good or service described by or associated with the message is sold to at least one mobile device user of the one or more mobile device users.

24. A messaging system for performing the method of claim 1, the system comprising:
a. a database server comprising a database of data associated with the one or more mobile device users, wherein each entry of the database comprises:
i. a unique identifier corresponding to one of the one or more mobile device users;
ii. the targeting parameters associated with said one of the one or more mobile device users;
iii. location data associated with said one of the one or more mobile device users;
b. one or more mobile devices comprising:
i. a network adapter, optionally wherein said network adapter is a cellular network adapter;
ii. a computer readable medium comprising:
1. a messaging receiving module configured to:
a. receive messages over the network adapter;
b. present the messages to the user of the mobile device, optionally wherein the message is presented on a display or screen
2. a tracking module configured to:
a. receive user input from a the input device identifying the targeting parameters;
b. determine the location of the mobile device, optionally wherein the location is determined using a location device or GPS device.
c. transmit the targeting parameters and the location to the database server over the network adapter;
c. at least one messaging server, wherein the messaging server is remote from the one or more mobile devices of the mobile device users, and comprises:
i. a message-creating module configured to:
1. create a message, optionally wherein said message is created from a first user input;
ii. a matching module configured to:
1. create a query comprising the target profile;
2. compare the target profile of the query to the targeting parameters of the mobile device users and identify at least one match between the query and the targeting parameters of the mobile device users;
3. identify the mobile device user identifier associated with at least one match, thereby providing at least one matched mobile device user;
iii. a message-sending module configured to:
1. send the message to the at least one matched mobile device user.
d. a communications network connecting the database, the one or more mobile devices, and the messaging server.

25. The system of claim 24, wherein the system further comprises a reporting module configured to:
a. access the database;
b. create a report based on the data in the database.;

26. The system of claim 25, wherein the report is presented to the user of the messaging server.

27. The system of claim 25 or claim 26, wherein the tracking information comprises a plurality of movement data, each comprising
a. a location identifier corresponding to a location; and
b. a time identifier corresponding to the time the respective mobile device was at said location.

28. The system of claim 24, wherein the at least one messaging server:
a. is a web-based server and comprises a first user account for a tenant and a second user account for a collective representative; or
b. comprises a first messaging server for a tenant and a second messaging server for a collective representative, optionally wherein the messaging servers are mobile devices.

29. The system of any of claims 24-28, wherein the modules of the system are collectively configured to perform the method of any of claims 1-16.
